(19) United States
(12) Patent Application Publication
(10) Pub. No.: US 2012/0048445 A1
(43) Pub. Date: Mar. 1, 2012

(54) PNEUMATIC TIRE

(75) Inventor: Masahiro Segawa, Osaka (JP)

(73) Assignee: TOYO TIRE & RUBBER CO., LTD., Osaka (JP)

(21) Appl. No.: 13/178,628

(22) Filed: Jul. 8, 2011

(30) Foreign Application Priority Data
Sep. 1, 2010 (JP) 2010-195988

(51) Int. Cl. B60C 9/02

(52) U.S. Cl. 152/548

(57) ABSTRACT

A pneumatic tire has a belt ply buried in a tread portion and a carcass ply running into an inner peripheral side of an end portion of the belt ply from a pair of bead portions. The carcass ply was divided in a tire width direction at the tread portion. A division width of the carcass ply is equal to or more than 35% of a maximum width of the belt ply. An auxiliary ply formed by reinforcement cords extending at an angle within a range of ±20 degrees with respect to the tire width direction is arranged in such a manner as to overlap with the carcass ply in an inner peripheral side of the end portion of the belt ply and extend out to an inner side in the tire width direction than the division end portion of the carcass ply.

### BACKGROUND OF THE INVENTION

1. Field of the Invention

The present invention relates to a pneumatic tire structured such that it can reduce a high-frequency road noise in the vicinity of 1 kHz at the time of traveling.

2. Description of the Related Art

In recent years, there is a tendency that a request for noise reduction of a tire is enhanced in accordance with a high class and high quality of a vehicle, and it is particularly important to lower a road noise which is generated by a transmission of a vibration caused by an unevenness of a road surface applied to a tread portion.

The present inventor has devoted himself to study of the road noise, accordingly has found a cross section higher order vibration mode affecting a high-frequency road noise in the vicinity of 1 kHz, by an analysis and an experiment, and has found such information that it is possible to suppress a vibration of a cross section higher order mode of a whole of the tire so as to effectively reduce the high-frequency road noise in the vicinity of 1 kHz, by lowering a mass of a center region while increasing a mass of a shoulder region, with regard to a mass distribution of the tire.

In a pneumatic tire described in Japanese Unexamined Patent Publication Nos. 10-157408 and 2007-283962, a carcass ply is divided at a tread portion for the purpose of improving durability, however, a sufficient mass difference cannot be provided between a shoulder region and a center region even by simply dividing the carcass ply, and an effect of lowering a high-frequency road noise is lacking. Further, in these documents, a reinforcement layer is additionally lapped over a division end portion of the carcass ply, however, since the reinforcement layer is formed by cords extending in a tire circumferential direction, it is not sufficient for suppressing a vibration in a cross section higher order mode, and also lacks the lowering effect of the high-frequency road noise.

### SUMMARY OF THE INVENTION

The present invention has been made in view of the above circumstances, and an object thereof is to provide a pneumatic tire which can reduce a high-frequency road noise in the vicinity of 1 kHz, by setting a mass difference between a shoulder region and a center region.

The object can be achieved by the following present invention. That is, the present invention provides a pneumatic tire comprising a belt ply buried in a tread portion, and a carcass ply running into an inner peripheral side of an end portion of the belt ply from a pair of bead portions via side wall portions, and divided in a tire width direction at the tread portion, wherein a division width of the carcass ply is equal to or more than 35% of a maximum width of the belt ply, and an auxiliary ply formed by arranging reinforcement cords extending at an angle within a range of ±20 degrees with respect to the tire width direction is arranged in such a manner as to overlap with the carcass ply in an inner peripheral side of the end portion of the belt ply and extend out to an inner side in the tire width direction than the division end portion of the carcass ply.

In the pneumatic tire according to the present invention, since the division width of the carcass ply is equal to or more than 35% of the maximum width of the belt ply, the division end portion of the carcass ply is arranged near the end portion of the belt ply, and the auxiliary ply overlaps with the carcass ply in the inner peripheral side of the end portion of the belt ply, the mass difference is provided between the shoulder region and the center region, in cooperation with the division structure of the carcass ply. Further, since the auxiliary ply is formed by arranging the reinforcement cord extending at the angle within the range of ±20 degrees with respect to the tire width direction, it is possible to effectively suppress the vibration in the cross section higher order mode of the tire so as to reduce the high-frequency road noise in the vicinity of 1 kHz.

In the present invention, it is preferable that the auxiliary ply overlaps in the inner peripheral side of the carcass ply. Accordingly, the internal pressure of the tire tends to act on the auxiliary ply, and it is possible to satisfactorily suppress the vibration in the cross section higher order mode of the tire so as to enhance the reducing effect of the high-frequency road noise.

In the present invention, it is preferable that the auxiliary ply is divided in the tire width direction at the tread portion, and a division width of the auxiliary ply is smaller than the division width of the carcass ply. According to the structure mentioned above, it is possible to more securely lower the mass of the center region of the tire so as to improve the reducing effect of the high-frequency road noise. In addition, since the auxiliary ply extends outward to the inner side in the tire width direction than the division end portion of the carcass ply, the mass is gradually lowered from the shoulder region to the center region, and it is possible to avoid a rapid mass change.

In the present invention, it is preferable that the reinforcement cords extend so as to be inclined with respect to the tire width direction, and the carcass cord constructing the carcass ply extends so as to be inclined with respect to the tire width direction in such a manner as to intersect inversely to the reinforcement cord in a portion overlapping with the auxiliary ply. According to the structure mentioned above, the rigidity in the shoulder region of the tire becomes higher, and the high-frequency road noise in the vicinity of 1 kHz is effectively reduced.

In the present invention, it is preferable that a mass per unit width of the auxiliary ply is smaller than a mass per unit width of the carcass ply. In this case as well, the mass difference is provided between the shoulder region and the center region of the tire, and it is possible to obtain the lowering effect of the high-frequency road noise in the vicinity of 1 kHz.

### BRIEF DESCRIPTION OF THE DRAWINGS

FIG. 1 is a half cross sectional view of a tire meridian showing an example of a pneumatic tire in accordance with the present invention;

FIG. 2 is a cross sectional view schematically showing plies in a tread portion;

FIG. 3 is a plan view showing the plies in the tread portion;

FIG. 4 is a plan view showing plies according to other embodiment of the present invention;

FIG. 5 is a cross sectional view schematically showing plies according to other embodiment of the present invention;

FIG. 6 is a cross sectional view schematically showing plies according to other embodiment of the present invention;

FIG. 7 is a cross sectional view schematically showing plies according to other embodiment of the present invention.

### DETAILED DESCRIPTION OF THE PREFERRED EMBODIMENTS

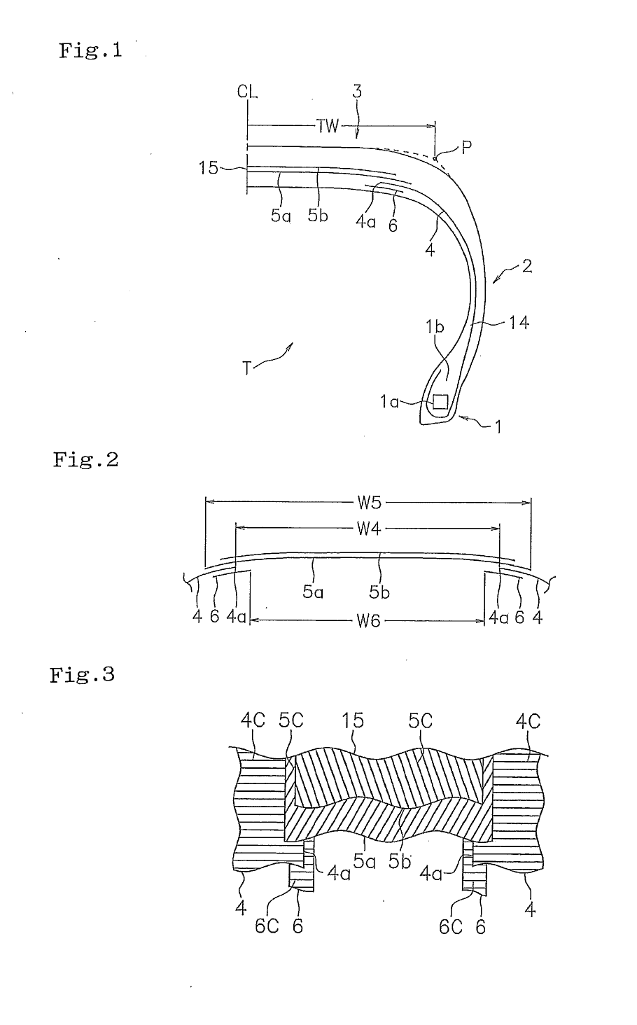

An embodiment of the present invention will be explained with reference to the drawings. FIG. 1 is a half cross sectional view of a tire meridian schematically showing an example of a pneumatic tire in accordance with the present invention. FIG. 2 is a cross sectional view schematically showing plies in a tread portion 3 of the tire. FIG. 3 is a plan view showing the plies, however, a cord in FIG. 3 is conceptually described, and an actual arrangement pitch is more dense.

A pneumatic tire T according to the present embodiment has a symmetrical structure with regard to a tire equator CL, and is provided with a pair of bead portions 1, side wall portions 2 extending to an outer side in a tire diametrical direction from the bead portions 1, and the tread portion 3 connected to an outer end in the tire diametrical direction of each of the side wall portions 2. Each of a pair of bead portions 1 is provided with an annular bead core 1a, and a bead filler 1b arranged in an outer side in the tire diametrical direction of the bead core 1a and made of hard rubber.

A plurality of layers (two layers in the present embodiment) of belt plies 5a and 5b forming a belt layer 15 are buried in the tread portion 3. Each of the belt plies 5a and 5b includes a belt cord 5C arranged at a predetermined angle of inclination (for example, 15 to 35 degrees) with respect to the tire circumferential direction, and the cord 5C is laminated in such a manner as to intersect inversely to each other between the plies. Steel fiber and organic fiber such as polyester, rayon, nylon, aramid, and the like are preferably used for the belt cord 5C. A belt reinforcement layer may be arranged in an outer peripheral side of the belt layer 5 as necessary.

The carcass ply 4 forming a carcass layer 14 runs into an inner peripheral side of an end portion of the belt ply 5a from a pair of bead portions 1 via the side wall portions 2, and its end portion is rolled back inward via a bead core la in the bead portions 1. The carcass ply 4 is provided as a toroidal shape as a whole, however, is divided in the tire width direction in the tread portion 3, and the division end portions 4a are separated from each other. The carcass ply 4 is formed by arranging the carcass cord 4C extending in a direction which is approximately orthogonal to the tire circumferential direction, and the steel fiber and the organic fiber mentioned above are preferably used for the cord 4C.

A division width W4 of the carcass ply 4 is determined based on the division end portion 4a, and is set, for example, to 40 to 60% of a tread width TW. The tread width TW can be determined as a distance in a tire width direction between two shoulder points Pat which a virtual line extending to the shoulder side at a radius of curvature of the tread surface intersects a virtual line extending to the shoulder side at a radius of curvature of buttress surfaces in both sides, in a meridian cross section of the tire.

Further, a maximum width W5 of the belt ply can be determined based on the wider belt ply 5a in the belt plies 5a and 5b forming the belt layer 15. In the present invention, the division width W4 of the carcass ply 4 is set to be equal to or more than 35% of the maximum width W5 of the belt ply, and the division end portion 4a is arranged in the vicinity of the end portion of the belt ply 5a. In light of a securement of the carcass ply 4 arranged in the inner peripheral side of the end portion of the belt ply 5a, it is preferable that the division width W4 is equal to or less than 80% of the maximum width W5.

An auxiliary ply 6 is provided so as to be formed in an annular shape along a tire circumferential direction at least in the shoulder region (at a position in an outer side in the tire width direction of the tread portion 3), overlaps with the carcass ply 4 in an inner peripheral side of an end portion of the belt ply 5a, and is arranged in such a manner as to extend out to an inner side in the tire width direction than the division end portion 4a of the carcass ply 4. The auxiliary ply 6 is formed by arranging a reinforcement cord 6C extending at an angle within a range of ±20 degrees with respect to the tire width direction, and the steel fiber and the organic fiber mentioned above are preferably used for the reinforcement cord 6C.

In the pneumatic tire T, since the auxiliary ply 6 overlaps with the carcass ply 4 in the inner peripheral side of the end portions of the belt plies 5a and 5b, a mass difference is provided between the shoulder region and the center region in cooperation with the division structure of the carcass ply 4. In other words, in the shoulder region, the mass is increased by the arrangement of the carcass ply 4 and the auxiliary ply 6. On the other hand, in the center region, the mass is lowered due to the lack of the carcass ply 4, and it is possible to achieve a sufficient mass difference between both the regions.

In addition, since the auxiliary ply 6 includes the reinforcement cords 6C which is arranged at the angle within the range of ±20 degrees with respect to the tire width direction, it is possible to effectively suppress the vibration in the cross section higher order mode of the tire . Since the vibration in the cross section higher order mode is such a vibration as to accompany a deformation of the tread portion 3 in the tire diametrical direction, a sufficient suppression effect cannot be obtained if the reinforcement cords 6C extend in the tire circumferential direction. As mentioned above, according to the pneumatic tire T, it is possible to reduce the high-frequency road noise in the vicinity of 1 kHz at the time of traveling.

The auxiliary ply 6 may be structured such as to overlap in an outer peripheral side of the carcass ply 4, however, the structure in which the auxiliary ply 6 overlaps in the inner peripheral side of the carcass ply 4 as in the present embodiment is preferable. Accordingly, the internal pressure of the tire tends to act on the auxiliary ply 6, and it is possible to satisfactorily suppress the vibration in the cross section higher order mode of the tire so as to enhance the reducing effect of the high-frequency road noise.

In the present embodiment, the auxiliary ply 6 is divided in the tire width direction at the tread portion 3, and a division width W6 of the auxiliary ply 6 is set to be smaller than the division width W4 of the carcass ply 4. Accordingly, it is possible to more securely lower the mass of the center region of the tire so as to improve the reducing effect of the high-frequency road noise. Further, since the auxiliary ply 6 extends outward to the inner side in the tire width direction than the division end portion 4a, the mass is gradually lowered from the shoulder region to the center region, and it is possible to avoid a rapid mass change.

In order to accurately enhance the mass of the shoulder region, it is preferable that the auxiliary ply 6 is arranged at least within a range of a region that is 5 to 35% of the maximum width W5 of the belt ply, from the end portion of the belt ply 5a toward an inner side in the tire width direction. Further, in order to accurately lower the mass of the center region, it is preferable that the division width W6 of the auxiliary ply 6 is equal to or more than 70% of the division width W4 of the carcass ply 4.

Dimensional values such as the widths W4 to W6 can be measured by an actual periphery in a cut sample obtained by cutting the tire into round slices vertically with respect to the tire equator CL and buffing in such a manner that the end portions of the cords such as the belt cord 5C and the like can be confirmed. The actual periphery is a length of a circular arc along a curvature in the tire width direction of the member to be measured at the time of mounting the cut sample on a horizontal table in such a manner that the buffed surface is directed upward, in a natural state in which an external stress is not applied. Accordingly, the widths W4 to W6 in FIG. 2 can be measured, not as a linear distance between two points, but actually as a length of the circular arc.

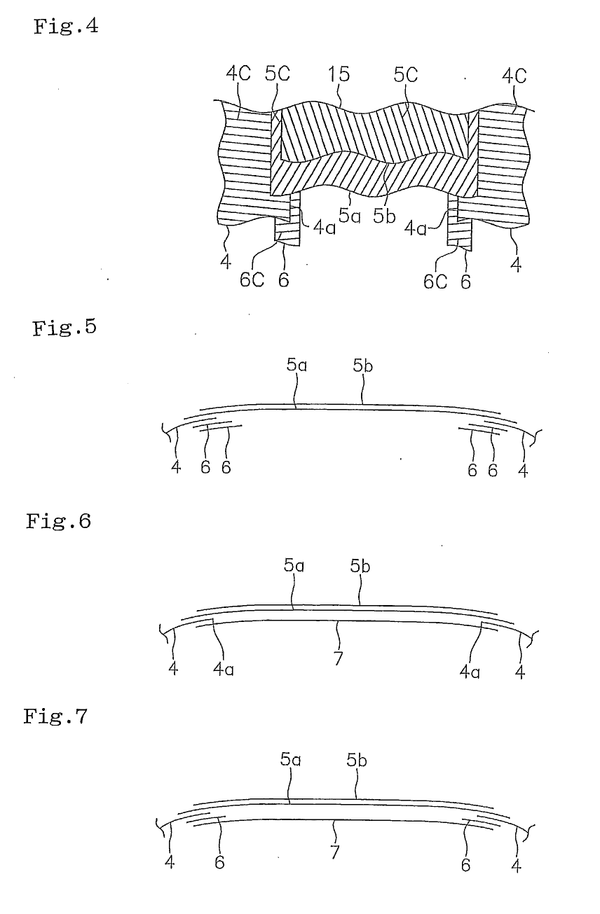

The reinforcement cord 6C is not limited to the structure which extends in parallel to the tire width direction, but may extend so as to be inclined with respect to the tire width direction as exemplified in FIG. 4. In this case, it is preferable that the carcass cord 4C extends so as to be inclined with respect to the tire width direction in such a manner as to intersect inversely to the reinforcement cord 6C in the portion overlapping with the auxiliary ply 6. Accordingly, rigidity in the shoulder region of the tire becomes higher, thereby becoming useful for lowering the high-frequency road noise in the vicinity of 1 kHz. In this case, an angle of inclination of the cords 4C and 6C with respect to the tire circumferential direction is, for example, between 70 and 85 degrees.

The auxiliary ply 6 is not limited to the structure which is provided in a single layer, but may be provided in a plurality of layers. In this case, it is preferable to shift the positions of the division ends between the auxiliary plies 6 as exemplified in FIG. 5, whereby the mass is lowered gradually from the shoulder region to the center region. In the structure mentioned above, the division width W6 of the auxiliary ply 6 is determined based on the division end which is positioned in the innermost side in the tire width direction.

In other embodiment shown in FIG. 6, in place of the auxiliary ply 6 mentioned above, there is arranged an auxiliary ply 7 which is formed by arranging a reinforcement cord extending at an angle within the range of ±20 degrees with respect to the tire width direction, overlaps with the carcass ply 4 in the inner peripheral side of the end portion of the belt ply 5a, and extends out to the inner side in the tire width direction than the division end portion 4a so as to extend to the center region. A mass per unit width of the auxiliary ply 7 is smaller than the mass per unit width of the carcass ply 4, and is structured such that the high-frequency road noise in the vicinity of 1 kHz can be lowered by setting the mass difference between the shoulder region and the center region. Accordingly, it is possible to secure outward bending rigidity of a surface in the width direction while securing the mass difference between the center region and the shoulder region, and it is possible to achieve an improvement of a wear resistance.

In order to set the mass difference per unit width between the auxiliary ply 7 and the carcass ply 4, it is possible to employ a technique for differentiating a material, a diametrical dimension and an end number (a cord number per unit width) of the cord. For example, the reinforcement cord constructing the auxiliary ply 7 may be formed by polyethylene naphthalate (PEN), and the carcass cord constructing the carcass ply 4 may be formed by steel. Alternatively, the diametrical dimension or the end number of the reinforcement cord may be made relatively smaller, and the diametrical dimension or the end number of the carcass cord may be made relatively larger. Further, the thickness per unit width of the auxiliary ply 7 may be made smaller than the thickness per unit width of the carcass ply 4.

Further, the auxiliary ply 7 may be structured such as to be divided in the tire width direction at the tread portion 3 in the same manner as the auxiliary ply 6 mentioned above, and the reinforcement cord extending so as to be inclined with respect to the tire width direction may be arranged. Further, the auxiliary ply 7 is not limited to be provided in a single layer, but may be provided in a plurality of layers. FIG. 7 shows an example in which the auxiliary ply 7 is used together with the auxiliary ply 6, and it is possible to lower the high-frequency road noise in the vicinity of 1 kHz, even in the structure mentioned above.

### EXAMPLE

In order to specifically show the structure and the effect of the present invention, noise performance with regard to the high-frequency road noise in the vicinity of 1 kHz was evaluated, which will be described below. In this performance evaluation, a test tire (tire size 225/45R17) was installed to a test vehicle (2.5 L FR vehicle, two persons ride) while setting a pneumatic pressure to 220 kPa (front wheel)/260 kPa (rear wheel) and setting a used rim to 17×8−JJ, and a road noise level (630 to 1.6 kHz) at the time of traveling at a speed 100 km/h on a road noise road of a test course was measured by using a microphone.

### Comparative Examples 1 and 2

In the tire structure in FIG. 1, Comparative Example 1 was set to a structure in which the carcass ply was not divided, but was connected at the tread portion and the auxiliary ply was not provided. Further, in the tire structure in FIG. 1, Comparative Example 2 was set to a structure in which the ply was arranged as shown in FIG. 2, and an angle of the reinforcement cord included in the auxiliary ply with respect to the tire width direction was set to 90 degrees.

### Examples 1 to 3

In the tire structure in FIG. 1, Example 1 was set to a structure in which the ply was arranged as shown in FIG. 2, Example 2 was set to a structure in which the ply was arranged as shown in FIG. 6, and Example 3 was set to a structure in which the ply was arranged as shown in FIG. 5. Results of the evaluation are shown in Table 1.

TABLE 1

| | Comparative | Comparative | | | |
|---|---|---|---|---|---|
| | Example 1 | Example 2 | Example 1 | Example 2 | Example 3 |
| Carcass ply | | | | | |
| Division | Absence | Presence | Presence | Presence | Presence |
| Thickness (mm) | 1.1 | 1.1 | 1.1 | 1.1 | 1.1 |
| Auxiliary ply | | | | | |
| Division | — | Presence | Presence | Absence | Presence |
| Thickness (mm) | — | 0.9 | 0.9 | 0.9 | 0.9 |
| Angle (*1) | — | 90° | 0° | 0° | 0° |
| Reinforcement cord | — | Polyester | Polyester | Polyester | Polyester |
| Number | — | 1 | 1 | 1 | 2 |
| Shape | | | FIG. 2 | FIG. 6 | FIG. 5 |
| Width W5 (mm) | 200 | 200 | 200 | 200 | 200 |
| Width W4 (mm) | — | 100 | 100 | 100 | 100 |
| Width W6 (mm) | — | 80 | 80 | 80 | 80 |
| W4/W5 | — | 50% | 50% | 50% | 50% |
| W6/W4 | — | 80% | 80% | 80% | 80% |
| Mass of position (*2) | | | | | |
| Shoulder | 100 | 106 | 106 | 106 | 115 |
| Center | 107 | 99 | 96 | 102 | 96 |
| Center/shoulder | 107 | 93 | 91 | 94 | 83 |
| Road noise level (dB) | 0 (reference) | −0.3 | −1.2 | −0.8 | −1.3 |

(*1): Angle of reinforcement cord with respect to tire width direction
(*2): Mass per unit width in total thickness of each of positions. This is expressed by an index number at the time of setting a shoulder of Comparative Example 1 to 100.

As shown in Table 1, in Comparative Example 2, the mass difference is provided between the shoulder region and the center region, however, it is not sufficient for suppressing the vibration in the cross section higher order mode, and the lowering effect of the high-frequency road noise is poor. On the contrary, in Examples 1 to 3, the high-frequency road noise in the vicinity of 1 kHz is effectively reduced.

What is claimed is:

1. A pneumatic tire comprising:
a belt ply buried in a tread portion; and
a carcass ply running into an inner peripheral side of an end portion of the belt ply from a pair of bead portions via side wall portions, and divided in a tire width direction at the tread portion, wherein
a division width of the carcass ply is equal to or more than 35% of a maximum width of the belt ply, and an auxiliary ply formed by arranging reinforcement cords extending at an angle within a range of ±20 degrees with respect to the tire width direction is arranged in such a manner as to overlap with the carcass ply in an inner peripheral side of the end portion of the belt ply and extend out to an inner side in the tire width direction than the division end portion of the carcass ply.

2. The pneumatic tire according to claim 1, wherein the auxiliary ply overlaps in the inner peripheral side of the carcass ply.

3. The pneumatic tire according to claim 1, wherein the auxiliary ply is divided in the tire width direction at the tread portion, and a division width of the auxiliary ply is smaller than the division width of the carcass ply.

4. The pneumatic tire according to claim 1, wherein the reinforcement cords extend so as to be inclined with respect to the tire width direction, and the carcass cord constructing the carcass ply extends so as to be inclined with respect to the tire width direction in such a manner as to intersect inversely to the reinforcement cord in a portion overlapping with the auxiliary ply.

5. The pneumatic tire according to claim 1, wherein a mass per unit width of the auxiliary ply is smaller than amass per unit width of the carcass ply.
